(19) United States
(12) Patent Application Publication
(10) Pub. No.: US 2015/0007294 A1
(43) Pub. Date: Jan. 1, 2015

(54) COMMUNICATION TRACKING AND MANAGEMENT SYSTEMS AND METHODS

(71) Applicant: Shuo Steven Wang, Rosemead, CA (US)

(72) Inventor: Shuo Steven Wang, Sierra Madre, CA (US)

(21) Appl. No.: 14/299,995

(22) Filed: Jun. 9, 2014

Related U.S. Application Data
(60) Provisional application No. 61/832,941, filed on Jun. 9, 2013.
(60) Provisional application No. 62/002,919, filed on May 26, 2014.

(51) Int. Cl. H04L 29/08; G06F 21/62; H04L 29/06

(52) U.S. Cl. CPC H04L 67/22; H04L 63/08; G06F 21/6245
USPC 726/7; 709/224

(57) ABSTRACT

Some exemplary embodiments of the present invention would be implemented for large companies where timely communications with customers, vendors, suppliers, and other entities and individual are important. Exemplary embodiments would provide a meta-view of pending communications by providing a pending communications queue that could be viewed by contact-initiators, contact-targets, and management and/or network administrators.

Exemplary pending communication queues would be viewable according to viewer selectable and/or definable criteria, such as, for example, by individual contact-initiator, by individual call target/contact receiver, by department other hierarchical entity, within an organization or within the communications network, or yet further, by organizations within a network of organizations, or by other selectable or definable criteria.

### CROSS REFERENCE TO RELATED APPLICATIONS

This application is a non-provisional application that claims priority to U.S. Provisional Patent Application Ser. No. 61/832,941, titled “METHOD FOR COMMUNICATION WITH HEALTHCARE PROVIDERS,” filed on Jun. 9, 2013, and U.S. Provisional Patent Application Ser. No. 62/002,919, titled “METHOD FOR COMMUNICATION WITH HEALTHCARE PROVIDERS,” filed on May 28, 2014, the entire disclosures and contents of all of which are incorporated herein in full by reference as if stated in full herein.

### FIELD OF THE INVENTION

The field of the present invention is communication systems and methods, and more particularly, communication tracking and management systems and methods.

### BACKGROUND OF THE INVENTION

Communication can be vital in many types of organizations. It is especially vital in the healthcare setting. Management and tracking of communications can also be important in social media. Yet further, multiple organizations may want to enter a cooperative communication network, such as, by way of a non-limiting, illustrative example, multiple healthcare organizations, such as, but not limited to, in a particular geographical area.

Yet, in many organizations, including the healthcare setting, communications can be uncentralized/decentralize and uncoordinated. In particular, in the healthcare setting, such as in hospitals, nurses from different stations may call the same doctor at the same, or nearly the same, time resulting in multiple calls to the same doctor in a short time period of time. Attempting to contact a physician can sometimes be time-consuming for each nurse that undertakes the contact, thereby resulting in inefficiencies in the time spent by nurses—time that could otherwise be more directly spent on patient care.

Also, in some hospitals nurses place calls to physicians at nurse stations or at hospital-provided phones which sometimes are not configured to make outbound calls without the assistance of a nurse station or hospital operator.

Further, doctors may be mandated by hospital by-laws to respond to nurse calls/contacts within a certain time frame. However, documentation of calls and call-return completion has not previously been digitized and/or centralized. Therefore, there has been no convenient or manageable way for healthcare organizations to track physician compliance with hospital by-law mandates regarding call-back timing.

Yet further, Electronic Medical Records (“EMRs”) have not previously provided a direct link between physician orders and actual responsive communications to facilitate the execution of those orders. Rather, when an attending physician issues an order for entry into a patient's EMR, such as an order for a consultation with a physician specialist, or with other types of healthcare providers, such as, for example, physical therapists, speech therapists, social workers, etc., healthcare personnel, such as nurses or hospital secretaries, must manually monitor each patient's EMR to identify entry of such orders, and then initiate a communication with the relevant target healthcare provider to request completion of/compliance with the order. Then, when the relevant target healthcare provider is notified of the order, nurse within the EMRs must be first recognized by nurses or secretaries and then carried out by calling or other communications.

Currently, in EMRs, there is no direct link between orders and actual communication to facilitate the execution of those orders. In other words, orders such as consultations with physicians or physical therapists, speech therapists, social workers, etc, within the EMRs must be first recognized by nurses or secretaries and then carried out by calling or other communications.

A way is needed that will allow users, including both callers and call targets, to see a list of entries for pending calls, and/or other types of contacts (such as, but not limited to, emails, text messages, pages, and the like) to a particular call target. A way is needed that would allow calling users (and/or users that initiate other types of communications, such as email, text, pages, etc.) to add themselves as an entry on a list/queue for the particular call target (recipient of the communication entry). Further, a way is needed to improve efficiency, reduce calls (and/or other contacts), and accurately record communication timelines and statistics. Yet further, a way is needed that will reduce the number of calls (and/or other contacts) from nurses in different nursing stations to the same physician or other healthcare provider.

Further still, a way is needed that would facilitate initiation and completion of calls (and/or other contacts), and recordation of call (and/or other contacts) results, such as within an Electronic Medical Records (EMR) system, at the same time and in the same place as the caller/contactor is attempting to render health care to a patient.

Yet further still, a way is needed to enhance process improvement for patient care, such as by determining and analyzing detailed statistics for healthcare provider communication patterns and patient needs.

### SUMMARY OF THE INVENTION

Exemplary embodiments of the present invention would provide systems and methods for managing and tracking communications between individuals within a particular communication network. Some exemplary embodiments of the present invention would provide systems and methods for managing and tacking communications between healthcare providers in a healthcare setting.

Exemplary embodiments would further provide communication tracking and management on personal smartphones to track and manage data from each individual “app” (a software application that may be downloaded to, and installed on, a personal intelligent telephone) to provide overall display and analysis of communication and patterns for inter-app communication.

As will be described with respect to further details below, exemplary embodiments would provide an exemplary “call queue” for each “call target” (an intended recipient of a call communication). The exemplary call queue would be viewable by both calling users (e.g., in a healthcare setting, nurses), as well as by call targets (e.g., in a healthcare setting, physicians, and/or other types of healthcare providers), as well as by those that may assist call targets (e.g., in a healthcare setting, a physician's office staff, a physician's answering service, a physician's assistant (“PA”), a nurse practitioner that is assisting a physician, or others assisting a healthcare provider). For example, exemplary nurses may view an exemplary call queue for an exemplary call target so that they can see whether the particular exemplary call target (e.g., a particular physician) has been called; if they wish to speak with the physician, they can add their name as an entry to the call queue. By adding their entry to the call queue for the particular exemplary call target, the exemplary caller does not need to place a call to the call target.

In a healthcare setting, because trying to contact a healthcare provider, such as a physician, can be time consuming (e.g., there may be a long recorded message that the caller may have to listen to in order to even leave a phone message, and/or get to an individual who will take a message, for the call target), then being able to add their entry to a call target's queue without having to place a telephone call to leave a message may sometimes itself save the caller's time and would further save the physician's time from receiving another call and telephone message. When the call target (e.g., a physician) views the queue of call list entries, the physician may call back to multiple nurses and/or other callers after having just received one call. Further, when the physician calls back, exemplary embodiment will comprise computer software that would record the call back time and would collect and track statistics regarding the original call and the call back; the exemplary embodiment would further comprise software that would analyze the statistics collected and would produce reports that could be used to aid physicians and hospitals to improve patient care processes.

Some exemplary embodiments may be implemented across a network of hospitals, physician offices, insurers, and other healthcare providers. Alternatively, some exemplary embodiments may be implemented in a non-healthcare setting across a network of multiple organizations. Implementation of exemplary embodiments would tend to reduce the number of outbound telephone calls and the time spent to place the calls, navigate a telephone tree to leave a message and leave a message. Implementation of exemplary embodiments would further tend to reduce the number of incoming telephone calls to an individual call target while still identifying “callers” and their reasons for and timing of their “call” initiation, and keeping statistics regarding various data and aspects of contacts.

One exemplary embodiment would comprise an exemplary computer system for communication management and tracking that would comprise at least one computer device programmed to perform the following processes: identifying a plurality of data elements for each contact between members of a communications network, said data elements for each contact comprising: an identification of a contact-initiator, an identification of a contact-target, a time of an initiation of a contact by said contact-initiator directed to said contact-target, a time of completion of a return-answer contact by said contact-target to said contact initiator, and a status of said contact, wherein said status comprises a completed contact where said time of completion has been identified, but where said status comprises a pending contact where said time of completion has not yet been identified. The at least one computer device of the exemplary embodiment computer system would be further programmed for creating an entry in a pending communications queue on a computer-accessible storage device for each contact for which the status of said contact is pending; and generating a visual display on a computer-accessible display device of each pending contact. In one such exemplary embodiment computer system the set of pending contact display criteria would comprise an identification of a particular contact-target, or would comprise an identification of a contact-target type. In one such exemplary embodiment computer system, the communications network would comprise a plurality of social media platforms. In one such exemplary embodiment computer system, the communications network would comprise a plurality of software applications installed on a particular personal intelligent telephone.

### BRIEF DESCRIPTION OF THE DRAWINGS

These and other features of the present invention are more fully set forth in the following description of exemplary embodiments of the invention. The description is presented with reference to the accompanying drawings in which:

FIG. 1 is a simplified graphic depiction of an exemplary physician with whom an exemplary healthcare staff member is talking using one of various possible communication links in an exemplary embodiment of the present invention;

FIG. 2 depicts a high-level set of alternative options for a caller to identify a call target to the exemplary embodiment of the present invention;

FIGS. 3 and 4 comprise graphic depictions of alternative views of an exemplary Health Provider Contact Information Screen in an exemplary embodiment of the present invention.

FIGS. 5 and 6 comprise graphic depictions of alternative views of an exemplary patient-specific Health Care Provider Contact Information screen in an exemplary embodiment of the present invention;

FIG. 7 is a high-level flow diagram that illustratively depicts exemplary high-level logic functions for managing calls to a call target in an exemplary embodiment of the present invention;

FIG. 8 is a graphic depiction of an exemplary Call/Contact Message Queue Entry screen in an exemplary embodiment of the present invention.

FIG. 9 is a simplified graphic depiction of an exemplary call target physician for whom an exemplary call queue is monitored by both the exemplary call target physician and by an exemplary call queue monitor in an exemplary embodiment of the present invention;

FIG. 10A is a graphic depiction of an exemplary Call Target Queue data structure in an exemplary embodiment of the present invention;

FIG. 10B is a graphic depiction of an exemplary call queue for an exemplary call target in an exemplary embodiment of the present invention;

FIG. 11 is a graphic depiction of an exemplary Call Target Queue summary report screen for an exemplary call target in an exemplary embodiment of the present invention;

FIG. 12 is a graphic depiction of an exemplary Pending Contact Queue View Selection Criteria screen in an exemplary embodiment of the present invention;

FIG. 13 is a graphic depiction of an exemplary statistical report that would be viewable by an exemplary healthcare-setting embodiment of the present invention;

FIG. 14 is a graphic depiction of an exemplary Social Media Platform Communications Meta-View display of communications pending as of particular date for a particular social media user in an alternative exemplary embodiment of the present invention; and

FIG. 15 is a graphic depiction of an exemplary management view screen 1500 in an exemplary organizational embodiment.

### DETAILED DESCRIPTION OF THE INVENTION

Some exemplary embodiments of the present invention would be implemented for large companies where timely communications with customers, vendors, suppliers, and other entities and individual are important. Exemplary embodiments would provide a meta-view of pending communications by providing a pending communications queue that could be viewed by contact-initiators, contact-targets, and management and/or network administrators.

Exemplary pending communication queues would be viewable according to viewer selectable and/or definable criteria, such as, for example, by individual contact-initiator, by individual call target/contact receiver, by department other hierarchical entity, within an organization or within the communications network, or yet further, by organizations within a network of organizations, or by other selectable or definable criteria.

For example, management could view exemplary communication queues for employees (and/or, e.g., departments), and could, using statistics and information gathered by the exemplary embodiment, identify an employee (or e.g., a department) that has a large number of un-answered communications (e.g., telephone calls, email messages or the like). Such an exemplary embodiment could categorize pending communications (including telephone calls, emails, and the like) for a call-recipient (whether individual, department, or other organizational unit) according to contact-initiator type (e.g., customers, vendors, suppliers, or others) so that viewing management could take action to identify and remedy response delay.

However, for purposes of illustratively describing some aspects of the present invention, reference is provided with respect to an exemplary embodiment in an exemplary healthcare.

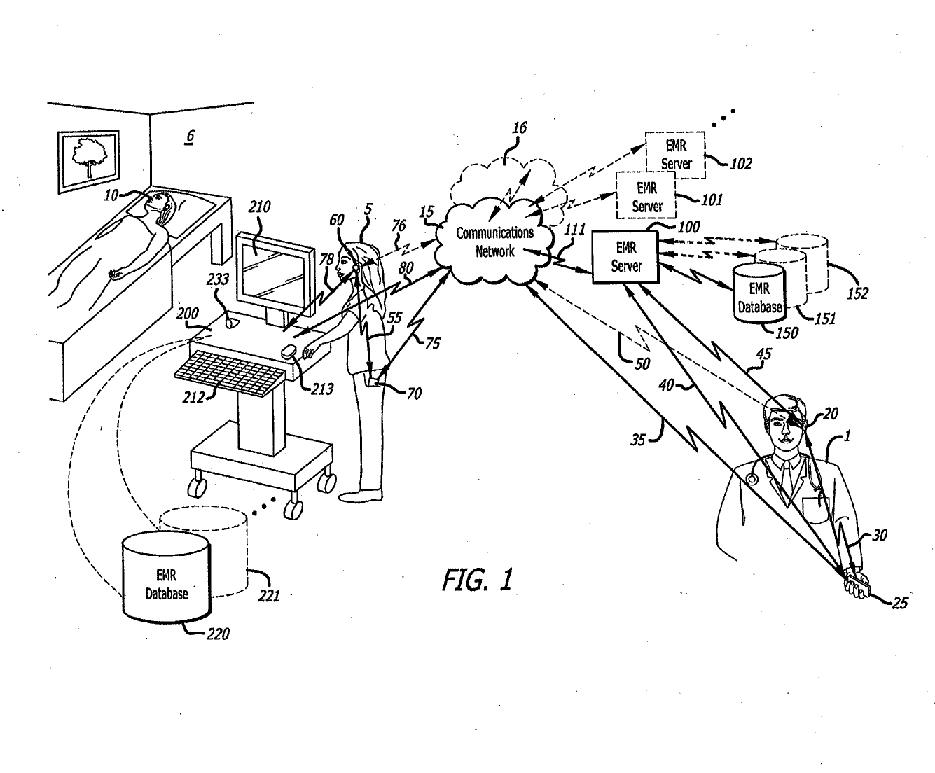

FIG. 1 is a simplified graphic depiction of an exemplary physician 1 with whom an exemplary healthcare staff member 5 is talking using one of various possible communication links. As illustratively depicted in FIG. 1, exemplary healthcare staff member 5 is caring for an exemplary patient 10 in an exemplary healthcare facility 6. As a result of efforts by exemplary healthcare staff member 5 to care for exemplary patient 10, a question, issue, or matter arises which exemplary healthcare staff member 5 for which exemplary healthcare staff member 5 wants to consult with exemplary physician 1.

Many of the exemplary embodiments described herein are illustratively described with respect to exemplary healthcare-setting communications, such as, by way of a non-limiting, illustrative example, nurse-to-physician communication management and tracking. However, as will be understood by someone with ordinary skill in the art, the present invention would not be limited to communications in a healthcare setting. Rather, alternative exemplary embodiments could be implemented in large organizations, in cooperative communication systems between organizations, in social media, and/or in other communication environments, without departing from the spirit of the present invention. For example, alternative exemplary embodiments could quantify, track, and coordinate inbound or outbound communications within large commercial organizations to, for example, enhance order fulfillment, customer service, compliance, and/or billing needs.

Further, many of the exemplary embodiments described herein are illustratively described with respect to telephone calls. However, exemplary embodiments of the present invention would not be limited to managing and tracking only telephone communications. Rather, some exemplary embodiments could be implemented to manage telephone, email, text, paging, and other types of communications, in healthcare settings, and also in commercial organization settings.

Reference herein to a “call” list or a pending “call” list queue will be understood to comprise a queue of pending contacts, whether telephone call, email, text message, paging, or other types of contacts, such as, but not limited to, social media postings, and the like, where the contact has been initiated by a caller/contact-initiator and directed to a contact-target (also sometimes referred to, and understood to include, a call-target, a contact-receiver and/or a contact-recipient), and where the contact-target.

Further reference and/or discussion herein of an exemplary embodiment taking some action (e.g., but not limited to, generating, displaying, analyzing, and the like) is to be understood by someone with ordinary skill in the art, as a disclosure that the exemplary embodiment (and/or any alternative exemplary embodiment) would comprise a computer device programmed with computer software to take the action described.

Returning with reference to FIG. 1, FIG. 1 graphically depicts exemplary healthcare staff member 5 communicating with exemplary physician 1 using one of various possible communication links that would be available in various exemplary embodiments of the present invention. For example, FIG. 1 depicts an exemplary communication link 75 from an exemplary personal intelligent (sometimes referred to herein as a “cell” phone) phone 70 (sometimes referred to herein as a “cell” phone), preferably a VOIP-enabled phone, for exemplary healthcare staff member 5 to an exemplary communications network 15.

In some exemplary embodiments, exemplary communications network 15 may comprise the Internet. However, in other exemplary embodiments, exemplary communications network 15 may comprise a Local Area Network (“LAN”), a Wide Area Network (“WAN”), a Wi-Fi (Wireless network) that may be connected to the Internet or to a LAN or WAN. The exemplary depiction and/or description of exemplary communications network 15 as alternatively comprising the Internet, a LAN, a WAN, or a Wi-Fi/Internet network is not a limitation of the present invention. Rather, communications may use one or more types of communications networks, whether now known or in the future discovered, to communicate with other parties without departing from the spirit of the present invention.

Further, exemplary embodiments implemented over a communications network, such as exemplary communications network 15 depicted in FIG. 1, may further comprise an “app” (a software application that may be downloaded to, and installed on, a personal intelligent telephone) that “call targets” in the network may download and install on their personal intelligent telephone, which may sometimes be referred to herein simply as a “cell” phone. However, as will be understood by someone with ordinary skill in the art, a “cell” phone may comprise VOIP (Voice-over-Internet-Protocol) software.

An exemplary embodiment “app” would provide a display to the cell phone call target user that would identify callers in the call list queue for that call target user; the “app” would update the display real-time and would also provide “alerts”, such as scrolling alerts, or alert windows, that would notify the call target user of each new caller entry to that call target user's call list queue.

In FIG. 1, one exemplary communication link 75 is depicted from an exemplary phone 70 for exemplary healthcare staff member 5 to an exemplary communications network 15; the exemplary healthcare staff member 5 may use an exemplary wireless headphone 60 which may, such as with Bluetooth wireless technology (or other wired or wireless technology whether now known or in the future discovered), communicate via an exemplary communication link 55 with the caller's exemplary phone 70.

FIG. 1 depicts an alternative communication path between exemplary wireless headphone 60 and an exemplary mobile workstation 200. In one exemplary embodiment, exemplary mobile workstation 200 would comprise an exemplary Electronic Medical Records (“EMR”) workstation 200 and the exemplary embodiment would comprise communication management and tracking systems and methods that are integrated with the EMR workstation 200 and EMR databases 220 (and, in some embodiments, additional EMR databases 221, . . . ), and/or with background EMR server computer 100 (and, in some embodiments, additional background EMR server computers 101, 102, . . . ) and/or background EMR databases 150 (and, in some embodiments, additional background EMR databases 151, 152, . . . ).

As will be understood by someone with ordinary skill in the art, an exemplary EMR system may comprise a centralized computer system and centralized EMR databases, that may be accessed by remote mobile EMR workstations, such as by the exemplary remote mobile EMR workstation 200 illustratively depicted in FIG. 1. However, as will be further understood by someone with ordinary skill in the art, an exemplary EMR system could comprise “Cloud” computing and/or “Cloud” storage (e.g., where logic processing may be provided on one or more server computer devices, and where physical storage may span across one or more server computer devices (and sometimes, multiple locations), where the physical storage and server computer device environment may be owned and/or managed by a third-party hosting company), and not itself be located in the same healthcare facility as the exemplary remote mobile EMR workstation 200 illustratively depicted in FIG. 1.

Alternatively, such as in smaller healthcare settings, an exemplary remote mobile EMR workstation such as the exemplary remote mobile EMR workstation 200 illustratively depicted in FIG. 1 may itself comprise an EMR-enabled computer system that accesses one or more EMR databases (e.g., exemplary EMR database 220, and optionally, further exemplary EMR databases 221 . . . ).

As a yet further alternative exemplary embodiment, an exemplary remote mobile workstation may be provided that comprises a standalone exemplary embodiment of the present invention that is not integrated with an Electronic Medical Records system, but which, by way of non-limiting, illustrative example, otherwise provides call-list queuing, communications tracking and management, and VOIP and VOIP video conferencing communications, as elsewhere described herein.

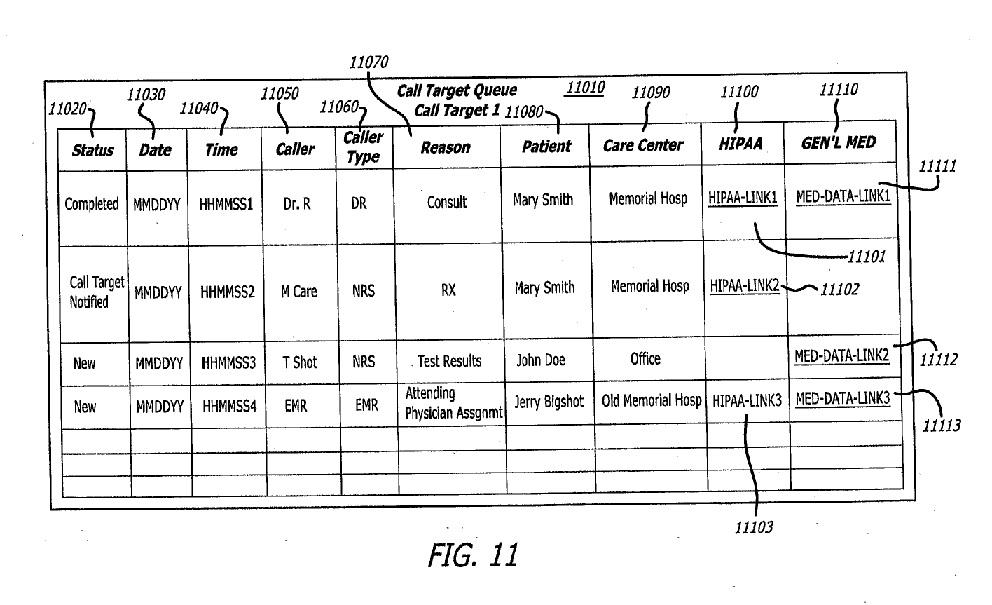

In an exemplary embodiment, exemplary EMR databases (e.g., EMR databases 220 (and, in some embodiments, additional EMR databases 221, . . . ) and/or background EMR databases 150 (and, in some embodiments, additional background EMR databases 151, 152, . . . ) may comprise HIPAA (Health Insurance Portability and Accountability Act of 1996) data for the particular patient for which communication is initiated between a caregiver (e.g., a nurse) and another healthcare provider (e.g., a physician). As will be understood by someone with ordinary skill in the art, HIPAA data entered by one nurse (such as through the exemplary remote mobile EMR workstation 200 illustratively depicted in FIG. 1) and intended for review by one or more doctors that are responsible for the healthcare of that particular patient should not be visible to others, including other healthcare providers, who do not possess authority to access such patient-specific HIPAA data. As will be described further below (with respect to FIG. 11, the exemplary embodiment would provide a link, such as a hypertext link, that would provide secure access (e.g., password-protected access and/or biometric-protected access) to patient-specific HIPAA data. By displaying such links to HIPAA data, the exemplary call list queue displays non-confidential data that may be reviewed by both the more general viewing population (callers, potential callers, call targets and/or call target assistants), and would provide secure access to confidential patient-specific HIPAA information that the authorized call-target may use to respond to the caller's call.

In an exemplary embodiment in which exemplary communication management and tracking systems and methods would be integrated with the subject EMR system (be that EMR system operable on a standalone workstation, such as exemplary mobile workstation 200 depicted in FIG. 1, or alternatively operable using exemplary mobile workstation 200 in conjunction with a background EMR System (such as is illustratively depicted by exemplary EMR Server 100 (and 101, 102, . . . ) and exemplary background EMR database 150 (and 151, 152 . . . ); whether communicatively connected via any of various types network communications), an exemplary “caller” (e.g., exemplary healthcare staff member 5) may communicate using the alternative communication link 78 between exemplary wireless headphone 60 and exemplary mobile workstation 200, and subsequently, via exemplary alternative communication link 80 between exemplary mobile workstation 200 and exemplary communications network 15.

In one exemplary embodiment, the exemplary remote mobile EMR workstation 200 illustratively depicted in FIG. 1 would comprise, or would be integrated with (such as on a server computer device (e.g., background EMR server computer 100 (and, in some embodiments, additional background EMR server computers 101, 102, . . . ) or, in the “Cloud”) what is sometimes referred to as “softphone” and/or “VOIP” (Voice Over Internet Protocol) and/or similar communications network telephone software, whether now known or in the future discovered. In such a softphone/VOIP embodiment, the exemplary remote mobile EMR workstation 200 would comprise software that would facilitate communication by an exemplary “caller” (e.g., exemplary healthcare staff member 5) using the alternative communication link 78 between exemplary wireless headphone 60 and exemplary mobile workstation 200, and subsequently, via exemplary alternative communication link 80 between exemplary mobile workstation 200 and exemplary communications network 15.

As mentioned above, instead of VOIP and/or softphone software (and/or VOIP video software) being installed on the exemplary workstation 200, in alternative embodiments, VOIP and/or softphone software could instead be installed on a server computer device (e.g., background EMR server computer 100 (and, in some embodiments, additional background EMR server computers 101, 102, . . . ) as depicted in FIG. 1 or, in the “cloud”); exemplary workstation 200 would be VOIP-capable using software that would be integrated to work with the VOIP and/or softphone software installed on the relevant server computer device(s) and/or over the “Cloud.”

Further, in one such exemplary embodiment, exemplary remote mobile EMR workstation 200 would further comprise software, as well as hardware components (e.g., exemplary telescoping/retractable, or wireless, video camera element 233 as depicted in FIG. 1), that would facilitate VOIP video conferencing with call targets, including with personal smartphones of call targets.

One exemplary embodiment would be further integrated for interface with various peripheral medical devices such as, but not limited to, electronic stethoscopes, high definition cameras, otoscopes, EKG machines and other peripheral medical devices, whether now known or in the future discovered, for telemedicine purposes.

In some such exemplary VOIP video-conferencing embodiments, the exemplary remote mobile EMR workstation 200 would comprise software (and/or the software would be provided on one or more relevant server computer devices (e.g., background EMR server computer 100 (and, in some embodiments, additional background EMR server computers 101, 102, . . . ))) that would, once a communication with the call target has been established, such as by a return call by the call target, facilitate the caregiver caller (i.e., the call originator) to use exemplary video equipment, such as, by way of non-limiting illustrative example, exemplary telescoping/retractable, or wireless, video camera element 233 as depicted in FIG. 1 to show the returning-call call target, physical symptoms exhibited by the subject patient and/or show medical data and/or information that would be difficult to otherwise communicate verbally.

As will be understood by someone with ordinary skill in the art, exemplary VOIP and VOIP video-conferencing mobile EMR workstation embodiments would be useful because cell-phone communications may not be available in some healthcare settings, such as in hospitals, and/or in certain departments in hospitals where cell phone communications may interfere with sensitive healthcare equipment.

In some further alternative exemplary embodiments, a further exemplary alternative communication link 76 could be used that communicates between exemplary wireless headphone 60 and exemplary communications network 15.

Similarly, a call target, such as exemplary physician 1, may use, in alternative embodiments, one or more communications links, such as exemplary communication link 30 between the call target's exemplary wireless headphone 20 and the call target's exemplary cell phone 25, and then with exemplary communication link 35 between the call target's exemplary cell phone 25 and the exemplary communications network 15. Alternatively, the call target may use a further alternative communication link 40 between the call target's exemplary cell phone 25 and an exemplary background EMR server 100. Other alternative communication links (e.g., 50 between the call target's exemplary wireless headphone 20 and the exemplary communications network 15; and/or 45 between the call target's exemplary wireless headphone 20 and an exemplary background EMR server 100) would be possible.

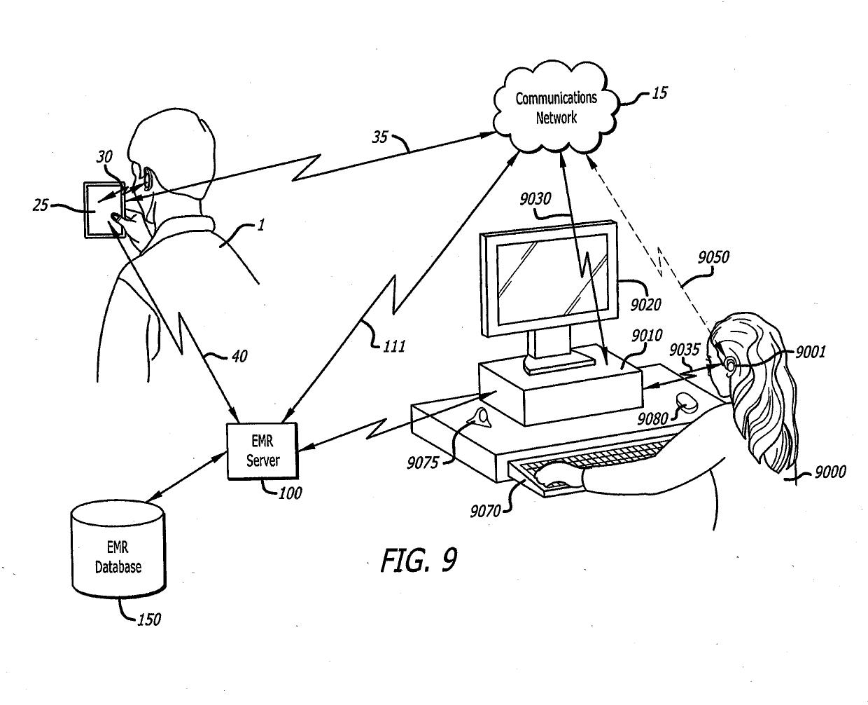

Exemplary embodiments would comprise software that would securely encrypt communications, including VOIP and VOIP-video communications, over the various exemplary communication links described herein. For example, VOIP and VOIP-video communications between exemplary mobile workstation 200 and the exemplary communication network 15, and between exemplary communication network 15 and the personal intelligent telephone 25 of the call target (as depicted in FIG. 1) and/or with exemplary remote monitoring computer 9010 as depicted in FIG. 9 would be encrypted so that communications would comply with HIPAA guidelines.

Further, exemplary embodiments would comprise software that would facilitate calendaring capabilities that would interface with calendars for the patient, as well as with calendars for the relevant call target(s), which may, in some cases, be provided on the call target's personal smartphone.

As will be understood by someone with ordinary skill in the art, using exemplary embodiments that would provide for EMR-integrated and/or standalone VOIP telephone calls from mobile workstations, nurses would not need to return to a nurse station or other hospital-provided phone in order to initiate and/or answer calls, and then return later to the mobile EMR workstation to document the physician call/consultation. Rather, using exemplary VOIP EMR-integrated mobile workstation embodiments, nurses would be able to document initiation and completion of telephone calls, as well as document the results of the physician call/consultation, within the subject Electronic Medical Record (EMR) system at the same time that they are communicating with the subject physician (or other healthcare provider).

As compared to existing EMRs where there is no direct link between physician orders for healthcare specialist care and/or consultation and subsequent, actual communication to facilitate the execution of those orders, an exemplary EMR-integrated embodiment would comprise software that would monitor entry of physician orders and would automatically act upon new physician orders to initiate communication of an order, and if need be, initiate follow-up communications of the order, and track provision of services to satisfy the order. Some exemplary EMR-integrated embodiments would coordinate communications between an attending nurse (and/or a set of attending nurses) and one or more healthcare specialists and would track the communications with respect to the originating physician orders to determine whether or not, and when, the order is satisfied.

An exemplary embodiment will comprise at least one exemplary computer device (e.g., background EMR server(s) 100 (and, in some embodiments, 101, 102, . . . ), and/or exemplary remote mobile EMR workstation 200, illustratively depicted in FIG. 1) that would be programmed to enable exemplary “callers” (or an exemplary “caller;” e.g., exemplary healthcare staff member 5) to initiate a call to another party (an exemplary “call target”; e.g., illustratively depicted in FIG. 1 as exemplary physician 1).

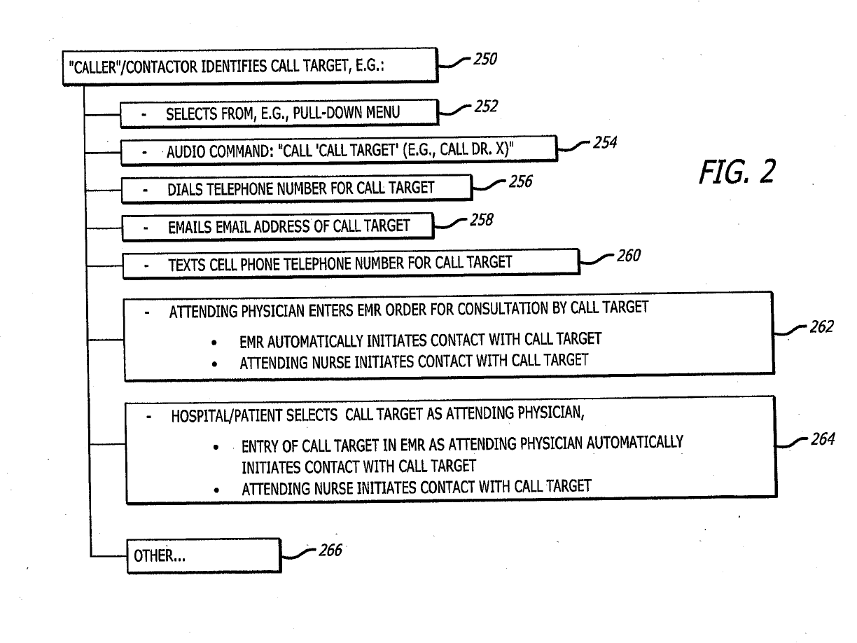

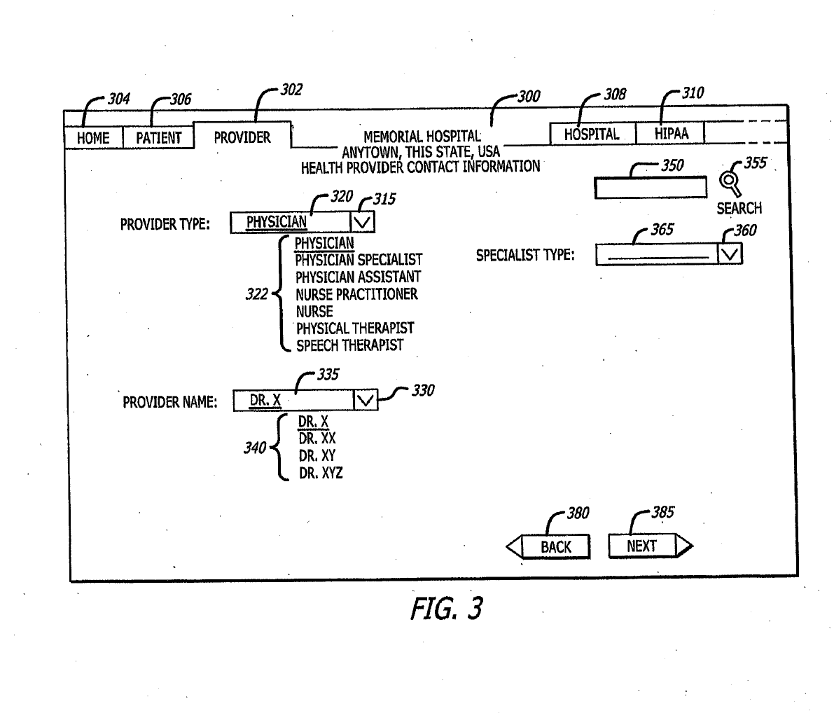

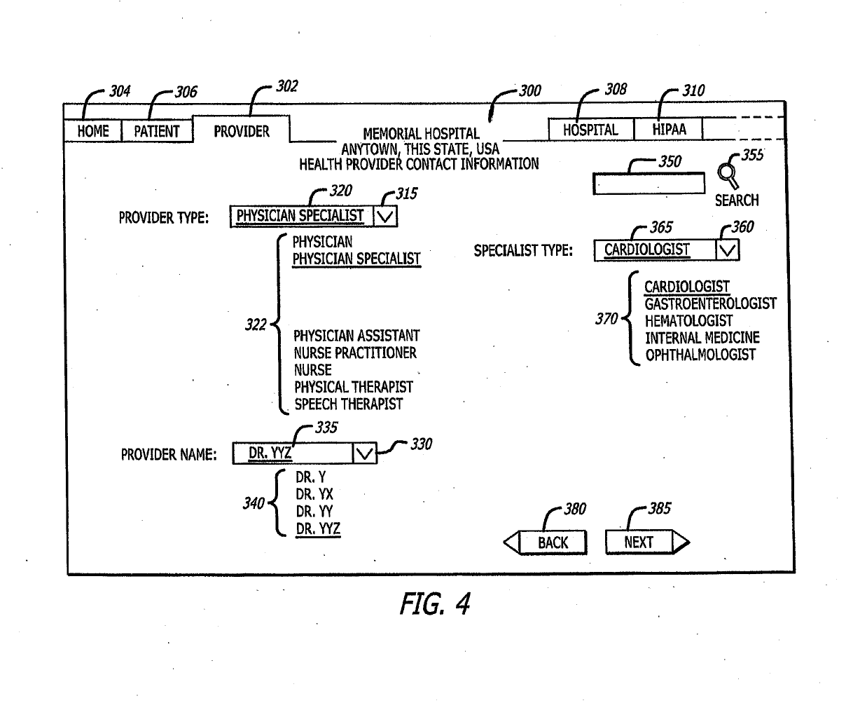

FIG. 2 depicts a high-level set of alternative options for a caller to identify a call target to the exemplary embodiment. As depicted in FIG. 2, the exemplary embodiment would provide a number of options for a “Caller”/Contactor to identify 250 a Call Target to the exemplary system. For example, the exemplary embodiment would comprise software that would facilitate an exemplary caller to select 252 an identification of a call target from an exemplary pull-down menu (see also, e.g., FIGS. 3 and 4). The exemplary embodiment would further comprise audio recognition software that would facilitate the caller verbally giving an audio command 254 to call Call Target (e.g., verbally says “Call Dr. X”). The exemplary embodiment would further comprise softphone and VOIP software that would facilitate the caller “dialing” 256 (e.g., using softphone software and VOIP software) a telephone number of the call target that is associated with the call target on a database (e.g., 220 (221, . . . ) and/or 150 (151, 152 . . . ) as depicted in FIG. 1) accessible by the exemplary embodiment. The exemplary embodiment would further comprise software that would facilitate a caller “emailing” 258 an email address for the call target that is associated with the call target on an exemplary database (e.g., 220 (221, . . . ) and/or 150 (151, 152 . . . ) as depicted in FIG. 1) accessible by the exemplary embodiment. Exemplary database (e.g., 220 (221, . . . ) may, in some embodiments, be accessible through the “Cloud.”

The exemplary embodiment would further comprise software that would facilitate a caller texting 260 the call target's cell phone number that is associated with the call target on a database (e.g., 220 (221, . . . ) and/or 150 (151, 152 . . . ) as depicted in FIG. 1) accessible by the exemplary embodiment. All of the aforementioned actions by an exemplary caller would be recognized by the software of the exemplary embodiment as an identification 250 by the exemplary caller of a Call Target.

Further, as depicted in exemplary process 262 in FIG. 2, the exemplary embodiment would further comprise software that would, upon an attending physician entering an EMR Order for a consultation by a call target, automatically initiate a contact (call, email and/or text) to the call target and/or notifies an attending nurse to initiate a contact with the call target.

Yet further, as depicted in exemplary process 264 in FIG. 2, the exemplary embodiment would further comprise software that, upon a hospital or patient selecting a call target as the patient's attending physician, and entering the call target in the EMR as the patient's attending physician, would automatically initiate a contact with the call target and/or would notify the attending nurse to initiate a contact with the call target.

In addition, other modes of identifying a call target 266 would be possible, including, but not limited to the exemplary embodiment would further comprise software that would facilitate paging a call target's pager.

Using one of the options illustratively depicted in FIG. 2, or other options whether now known or in the future discovered, for identifying a call target, a caller would identify a call target and initiate communications with the subject call target.

Returning with reference to FIG. 1, exemplary remote mobile EMR workstation 200 is illustratively depicted as comprising an exemplary display monitor 210, an exemplary keyboard 212, and an exemplary navigational device 213 (e.g., an exemplary “mouse” (whether wired or wireless)). Using exemplary keyboard 212 and/or exemplary mouse 213, the exemplary caller (e.g., exemplary healthcare staff member 5) may access one of various exemplary input screens that would be provided in an exemplary embodiment and displayed on exemplary display monitor 200. Alternatively, or in addition, the exemplary embodiment would comprise voice recognition software that would facilitate data input without mouse or keyboard entry.

FIG. 3 (and see also, FIG. 4) is a graphic depiction of an exemplary Health Provider Contact Information Screen 300. An exemplary Health Provider Contact Information Screen 300 would illustratively depict a particular Provider section or tab (e.g., exemplary Provider tab 302) of the relevant system, e.g., an EMR system, from a number of sections or tabs (e.g., exemplary Home tab 304, exemplary Patient tab 306, exemplary Hospital tab 308 and exemplary HIPAA tab 310).

An exemplary Health Provider Contact Information Screen 300 (see FIGS. 3 and 4) would further provide an exemplary Provider Type pull-down menu (elements 315 and 322). In the exemplary Health Provider Contact Information Screen 300 illustratively depicted in FIG. 3, an exemplary Provider Type pull-down menu (elements 315 and 322) has been activated and a particular Provider Type 320 has been selected, causing a display of an exemplary pull down menu 330 and 340 of doctor names that are associated (such as in a database accessible by the exemplary embodiment) with the selected Provider Type (e.g., element 320). As depicted in FIG. 3, an exemplary provider name (“Dr. X”) 335 has been selected from the exemplary pull down menu 330 and 340 of doctor names. The exemplary Health Provider Contact Information Screen 300 further provides an exemplary Specialist Type pull-down menu 360 and input field 365.

FIG. 4 is a graphic depiction of an exemplary Health Provider Contact Information Screen 300. In FIG. 4, the exemplary Specialist Type pull-down menu 360 and 370 has been activated and a particular Specialist Type 365 has been selected, causing a display of an exemplary pull down menu 330 and 340 of doctor names that are associated (such as in a database accessible by the exemplary embodiment) with the selected Provider Type (e.g., element 320) and the selected Specialist Type 365. In FIG. 4, a particular provide name 335 (“Dr. Yyz”) has been selected from the exemplary pull down menu 330 and 340 of doctor names that are associated (such as in a database accessible by the exemplary embodiment) with the selected Provider Type (e.g., element 320) and the selected Specialist Type 365.

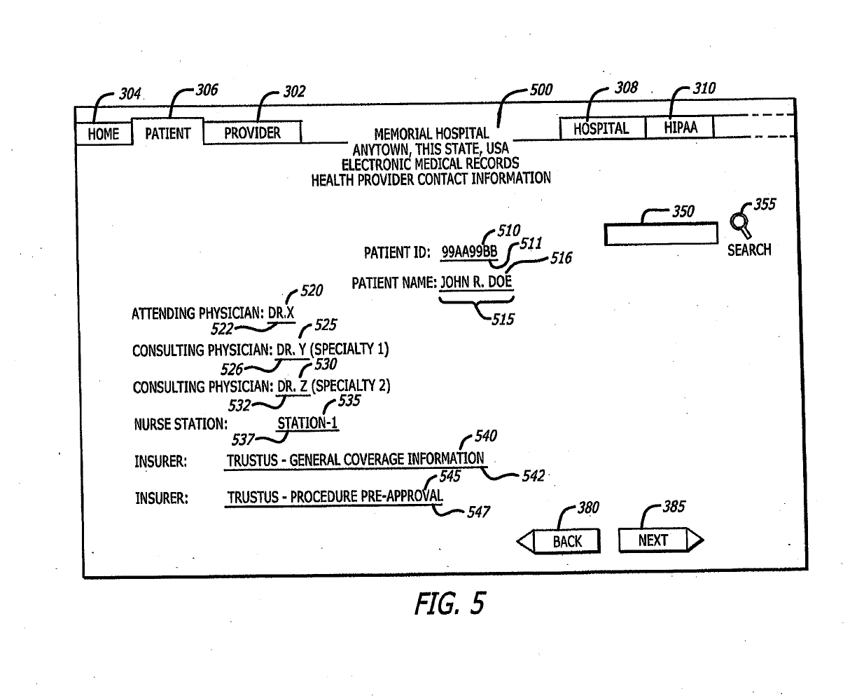

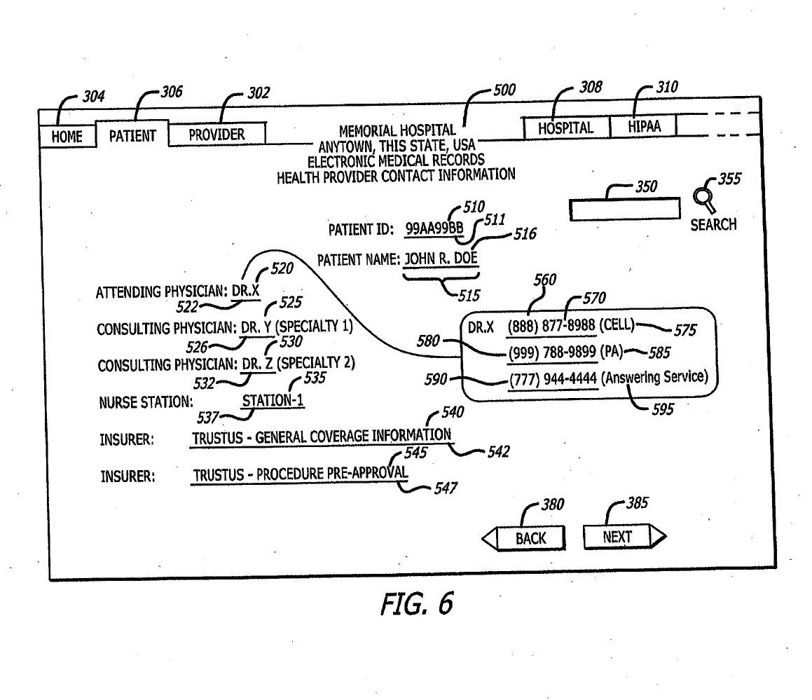

As illustratively depicted in FIGS. 3 and 4 (and see also, e.g., FIGS. 5 and 6), the exemplary embodiment would comprise software that would facilitate searching. Exemplary search icon 355 would activate a search for a search term or terms entered into the search term input field 350. The exemplary embodiment would facilitate that auto-complete/auto-anticipate search term capability where the user need only enter the first few letters of a search term that will activate a display of a list of possible search terms for user selection; if none of the displayed search terms satisfies the user's search requirement, the user may complete the entry of the search term or terms in the exemplary search term input field 350.

As further illustratively depicted in FIGS. 3 and 4 (and see also, e.g., FIGS. 5 and 6), the exemplary embodiment would further comprise exemplary navigation software that would facilitate exemplary screen-to-screen navigation, such as with exemplary Back button 380 and exemplary Next button 385.

FIGS. 5 and 6 comprise graphic depictions of an exemplary patient-specific Health Care Provider Contact Information screen 500. As depicted in FIG. 5, the exemplary embodiment would comprise software that would facilitate display of exemplary patient-specific Health Care Provider Contact Information screen 500. Exemplary patient-specific Health Care Provider Contact Information screen 500 would illustratively depict an exemplary Patient section or tab (e.g., exemplary Patient tab 306) of the relevant system, e.g., an EMR system, from a number of sections or tabs (e.g., exemplary Home tab 304, exemplary Provider tab 302, exemplary Hospital tab 308 and exemplary HIPAA tab 310). The exemplary patient-specific Health Care Provider Contact Information screen 500 would comprise an exemplary Patient ID input field 511; as depicted in FIG. 5 (and see also, FIG. 6), a particular patient ID 510 has been input. As depicted in FIGS. 5 and 6, the exemplary embodiment would comprise software, that in response to inputting (by keyboard or verbally with audio recognition software) a patient ID 510, would display a particular patient's name 516, or for a first entry of a patient's ID; would provide an input field 515 for entry of the patient's name. The exemplary embodiment would further comprise software to display various interactive fields for input of patient-specific information, including for an Attending Physician 522, a Consulting Physician 526 and 532, an attending Nurse Station 537, and Insurer identification 542 and 547. The exemplary patient-specific Health Care Provider Contact Information screen 500 depicted in FIGS. 5 and 6 depict entry of a particular patient's name 516, a particular Attending Physician 520, a particular first Consulting Physician 525, a particular second Consulting Physician 530, a particular attending Nurse Station 535, and particular Insurer Information 540 and 545.

As depicted in FIG. 6, the exemplary embodiment would comprise software that would sense e.g., hovering a cursor (not shown) over any particular provider, such as is shown for the exemplary particular Attending Physician (“Dr. X”), would cause a further interactive window display 560 of “active” contact information e.g., “activatable” phone numbers (cell 575 number 570; Physician's Assistant (PA) 585 number 580, and Answering Service 595 number 590) for the particular provider over which the cursor is hovered (e.g., Dr. X as depicted in FIG. 6. For example, the cell phone number 570, as well as the PA's number 580 and the Answering Service number 590 would all be “activatable”—that is, clicking any of those numbers would activate a call (e.g., a VOIP call) to the relevant number; softphone software would further provide a numeric telephone keypad display for use in the event that a pager or phone tree electronic phone system is encountered.

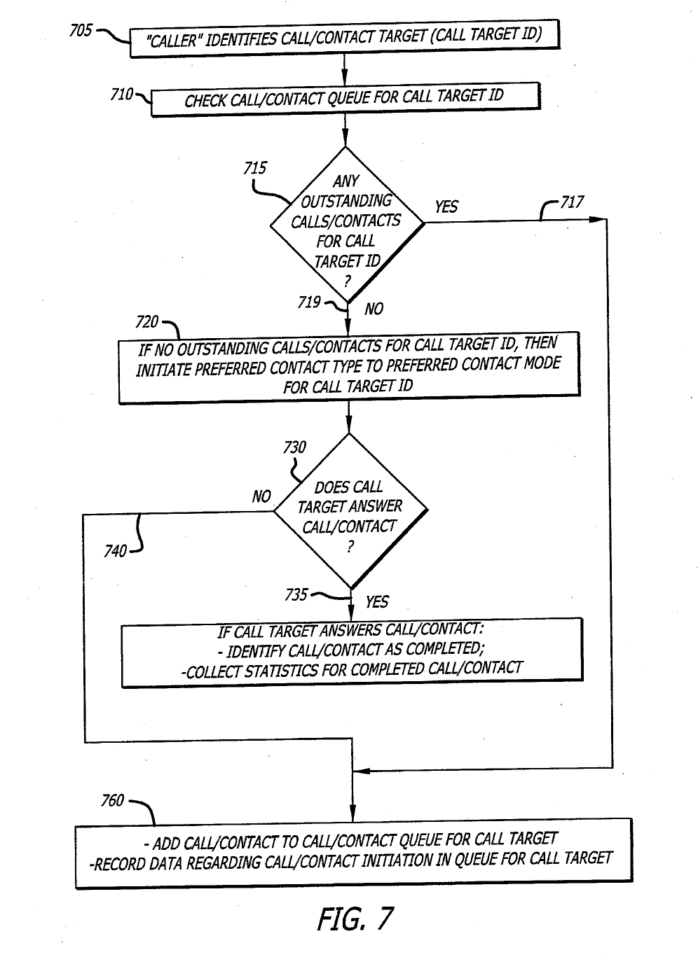

FIG. 7 is a high-level flow diagram that illustratively depicts exemplary high-level logic functions for managing calls to a call target. As depicted in FIG. 7, an exemplary “caller” would identify 705 a call target (such as with one of the options outlined in FIG. 2) to the exemplary embodiment. The exemplary embodiment would comprise software that would check 710 an exemplary call/contact queue for the relevant call target ID. The exemplary embodiment would comprise software that would check 715 to see if there were already any outstanding calls/contacts for the relevant call target ID. If outstanding calls/contacts exist (the “Y” path 717, then the exemplary embodiment would proceed to exemplary add-entry-to-call-list-queue process 760 as is described further below.

If, on the other hand, there are no outstanding calls/contacts for the particular call target ID, then the exemplary embodiment would comprise software that would initiate 720 a preferred contact type to a preferred contact mode for the relevant call target ID.

The exemplary embodiment would further comprise software that would check 730 to see if the call target answered the call/contact. If the call target did not answer (the “N” path 740), then the exemplary embodiment would comprise software that would proceed to exemplary add-entry-to-call-list-queue process 760 as is described further below.

If, on the other hand (the “Y” path 735), the call target answers, the exemplary embodiment would comprise software that would identify the call/contact as completed, and would collect statistics for the completed call/contact.

In cases where the call target doesn't answer a call/contact, and/or if there were already outstanding calls/contact pending for the call target in the call target's queue, the exemplary embodiment would comprise software that would add 760 the call/contact to the call/contact queue for the call target and would record data regarding the call/contact initiation in the queue for the call target.

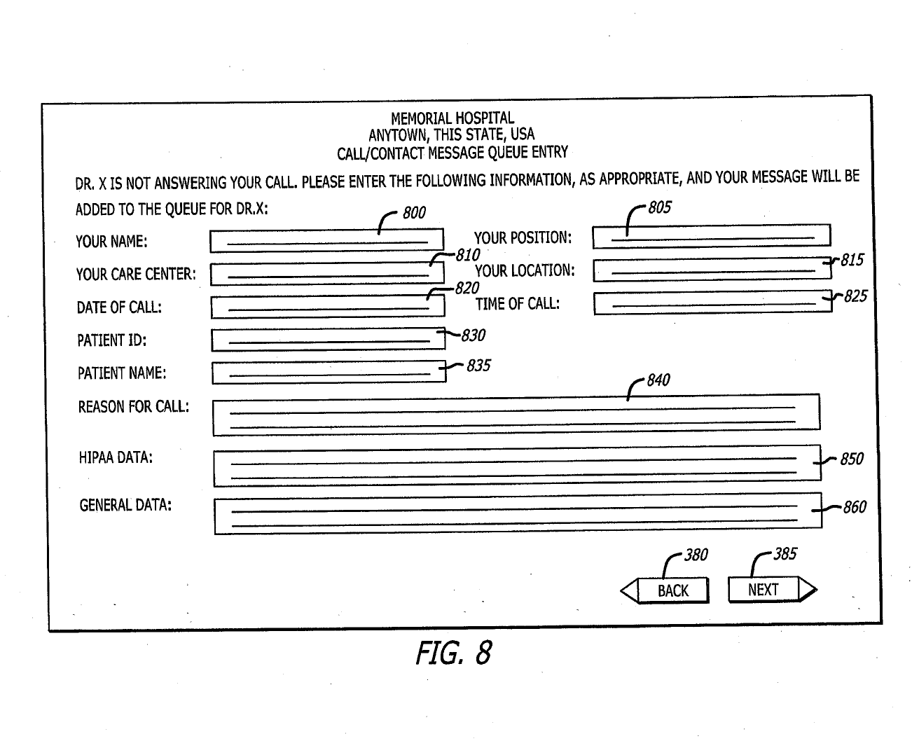

As an alternative, if the call is not completed, the exemplary embodiment could comprise software that would facilitate the exemplary caller (e.g., exemplary healthcare staff member 5 as illustratively depicted in FIG. 1) to interactively add a communication entry to a call queue for the particular call target (e.g., illustratively depicted in FIG. 1 as exemplary physician 1). For example, FIG. 8 is a graphic depiction of an exemplary Call/Contact Message Queue Entry screen in an exemplary embodiment of the present invention. If a call by the exemplary caller to the exemplary call target is not completed, in order to enter a call into a call queue for the call target, the exemplary embodiment would comprise software that would facilitate the exemplary caller (e.g., exemplary healthcare staff member 5 as illustratively depicted in FIG. 1) to interactively enter data (e.g., using a keyboard and/or voice recognition software) into relevant interactive display data fields. In order to access a call queue for a particular call target, the exemplary caller would need to have identified the intended call target, such as by using one of the ways described with respect to FIGS. 2-6. Once the caller has indicated the person with whom they wish to communicate, the exemplary embodiment would comprise software that would facilitate the caller to interactively enter the caller's name into interactive name input field 800, the caller's position into interactive position input field 805, and the caller's care center into interactive care center input filed 810.

In some embodiments, an exemplary caller would enter their location into exemplary Location input field 815; in other embodiments, entry into exemplary Location input field 815 and recordation of the caller's location will be accomplished automatically according to Global Positioning Software (“GPS”) (of a type whether now known or in the future discovered) that is integrated with the exemplary embodiment.

In some exemplary embodiments, the exemplary embodiment would comprise software that would automatically enter the date and time of the call/contact into exemplary interactive date and time of call input fields 820 and 825 once the caller has completed their input and has indicated completion. In other embodiments, the caller would enter the date and time data.

The exemplary embodiment will further comprise software that would enable the exemplary caller to enter into interactive display data fields, additional information regarding the reason for their call 840, HIPAA data 850, and other General data 860.

The exemplary embodiment would facilitate auto-complete/auto-anticipate interactive input into the above-mentioned interactive input fields so that the user would need only enter the first few letters of input such that the first few letters would activate a display of a list of possible input data for user selection; if none of the displayed input data satisfies the user's input requirement, the user may complete the entry of the input data in the relevant exemplary input field.

Once a call queue entry is created, the exemplary embodiment will allow certain people to view the call queue for a particular call target. In some exemplary embodiments, all persons that have access to the exemplary embodiment may view all call queues for all call targets. In other exemplary embodiments, the call target may restrict viewing of the call target's call queue to certain types of users, such as, for example, nurses, and those that have been hired to assist the call target.

Once a call queue entry has been added, the exemplary embodiment would comprise software that would allow the call-initiating user to edit their entry/ies to indicate an entry was an error; after making an edit change, the in-error entry can be made invisible to other users. However, the exemplary editing capability to indicate an error would be limited to being made by the user who initiated the entry, or to authorized administrative personal (e.g., in the event that a call initiator left the services of the relevant care facility.

FIG. 9 is a simplified graphic depiction of an exemplary call target physician 1 for whom an exemplary call queue is monitored by both the exemplary call target physician 1 and by an exemplary call queue monitor 9000. As depicted in FIG. 9, in the exemplary embodiment, an exemplary personal smartphone 25 for the exemplary call target physician 1 may communicate directed with an exemplary EMR Server 100 using exemplary communication link 40, or may communicate through exemplary communication link 35 with the exemplary communication network 15, which may then in turn communication with exemplary EMR Server 100. As will be understood by someone with ordinary skill in the art, the exemplary communication links depicted in FIG. 9 are illustrative and non-limiting. Further, the depiction of communications with an EMR Server 100 are illustrative and non-limiting in that in some exemplary embodiments, the call queue tracking and management features described herein are not integrated with an EMR system.

As further illustratively depicted in FIG. 9, an exemplary call queue monitor 9000, such as, for example, an answering service, the physician call target 1's office staff, or others, may monitor the call queue for a call target using an exemplary remote monitoring computer 9010 using an display monitor 9020, an exemplary input keyboard 9070, an exemplary mouse 9080, exemplary voice recognition software (not depicted), and exemplary video device 9075. The exemplary monitoring computer device 9010 may communicate directly with a server computer on which the exemplary embodiment software is executing, such as, for example, exemplary server 100. Alternatively, the exemplary monitoring computer device 9010 may communicate through an exemplary communication network 15, which would then communicate with exemplary server 100. The exemplary call queue monitor 9000 may communicate verbally using an exemplary headset 9001, which may use VOIP and softphone software on the exemplary monitoring computer device 9010 to communicate with exemplary call target physician 1. Alternatively, the exemplary headset may in some exemplary embodiments itself comprise VOIP software that would facilitate communications with the exemplary call target physician 1's exemplary phone 25.

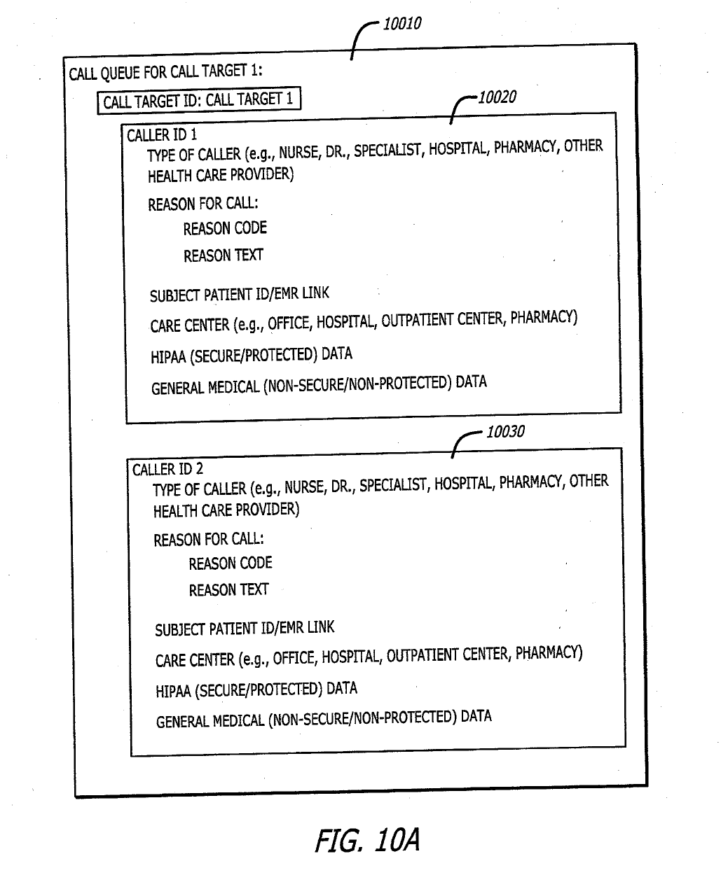

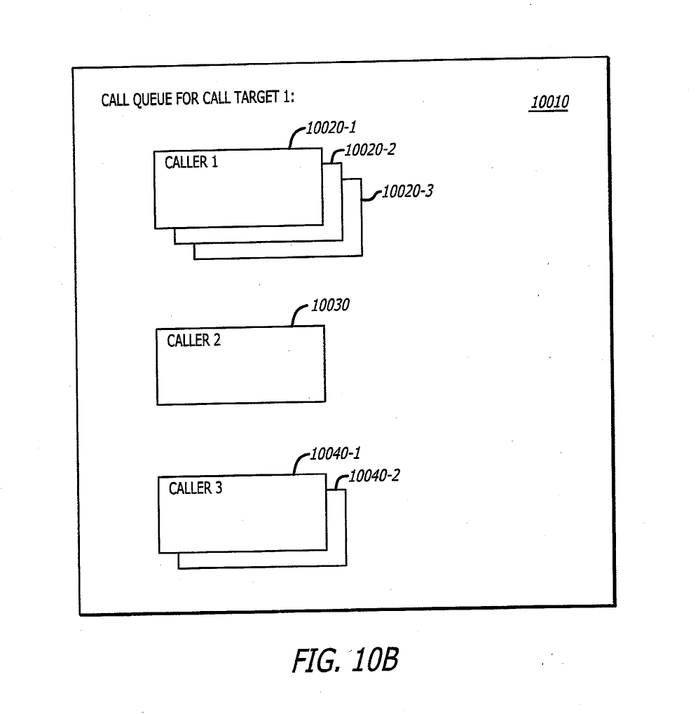

FIG. 10A depicts an exemplary Call Target Queue data structure. As depicted in FIG. 10A, an exemplary Call Target Queue would comprise an entry, e.g., exemplary entries 10020 and 10030 for each caller.

In some exemplary embodiments, if a call target does not answer a first call from a first caller, the first caller could place a follow-up call/contact, possibly resulting in a further entry for that first caller in the call target's queue. The exemplary embodiment would comprise software that would identify the follow-up call entry as a follow-up call; the call date and time of the follow-up call would be recorded. If no return call is made, the first caller could enter further follow-up calls, and each subsequent follow-up call would be identified as a further follow-up call, with the date and time of the further follow-up calls recorded. FIG. 10B graphically depicts an exemplary graphic display of an exemplary call queue 10010 for an exemplary call target 1. As depicted in FIG. 10B, exemplary call queue entry 10020-1 for exemplary caller 1 was an initial contact by exemplary caller 1; exemplary call queue entries 10020-2 and 10020-3 are follow-up calls by the same caller. As depicted in FIG. 10, exemplary call queue entry 10030 was an initial contact by exemplary caller 2; exemplary call queue entry 10040-1 was an initial contact by exemplary caller 3; exemplary call queue entry 10040-2 was a follow-up call or contact by exemplary caller 3.

FIG. 11 graphically depicts an exemplary Call Target Queue summary report screen 11010 for exemplary call target 1. The exemplary Call Target Queue summary report screen 11010 depicted in FIG. 11 may be viewable on the display of the call target user's cell phone (see, e.g., element 25 depicted in FIGS. 1 and 9), and/or on an exemplary display monitor 9020 viewed by an exemplary call queue monitor 9000 as depicted in FIG. 9, and/or by an exemplary caller, such as, for example, exemplary healthcare staff member 5 viewing exemplary display monitor 210 of exemplary workstation 200 (depicted, e.g., in FIG. 1) and/or through viewing a display on the exemplary healthcare staff member's personal intelligent telephone 70 (e.g., a VOIP-enabled handheld phone) depicted in FIG. 1.

The exemplary Call Target Queue summary report screen 11010 depicted in FIG. 11 is illustrative and non-limiting. It depicts a pending contact queue summary that would be displayed according to an identification of a particular contact target. However, as will be understood by someone with ordinary skill in the art, that particular display criteria would not be a limitation of the present invention. Rather, in some exemplary embodiments, a contact queue viewer would be presented with display options for viewing a pending contact queue.

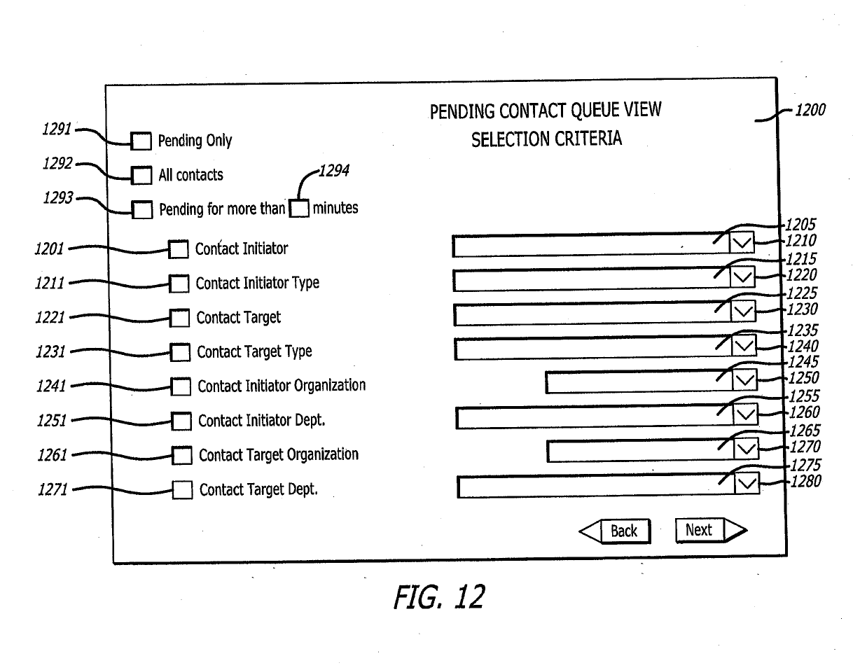

FIG. 12 is a graphic depiction of an exemplary Pending Contact Queue View Selection Criteria screen 1200. As depicted in FIG. 12, a plurality of exemplary pending contact queue view selection criteria would be presented, comprising, for example: Contact Initiator 1201, Contact Initiator Type 1211, Contact Target 1221, Contact Target Type 1231, Contact Initiator Organization 1241, Contact Initiator Department 1251, Contact Target Organization 1261, and Contact Target Department 1271.

For each of the exemplary pending contact queue view selection criteria, a corresponding pull-down menu and section criteria identification fields would be provided. For example, for a viewing user's selection of Contact Initiator 1201, the viewing user could either input a particular Contact Initiator's name and/or identifier in the interactive Contact Initiator Name/Identifier input field 1205, or the viewing user could click on the corresponding pull-down menu button 1210, which would in turn present a pull-down menu (not shown) of names and/or identifiers for Contact Initiators (e.g., persons within the relevant communications network) from which the viewing user could select in order to complete the interactive Contact Initiator Name/Identifier input field 1205. For example, in a healthcare setting, a viewing user might want to see the pending communications initiated by a particular nurse. So the viewing user could check the Contact Initiator 1201 selection criteria option and then could either enter into the name and/or identifier of the particular nurse into the interactive Contact Initiator Name/Identifier input field 1205, or could click on the corresponding pull-down menu button 1210, which would in turn present a pull-down menu (not shown) of names and/or identifiers for Contact Initiators (e.g., persons within the relevant communications network) from which the viewing user could select the name and/or identifier of the particular nurse in order to complete the interactive Contact Initiator Name/Identifier input field 1205.

Similarly, for a viewing user's selection of Contact Initiator Type 1211, the viewing user could either input a particular Contact Initiator Type in the interactive Contact Initiator Type input field 1215, or the viewing user could click on the corresponding pull-down menu button 1220, which would in turn present a pull-down menu (not shown) of Contact Initiator Types (e.g., job types and/or professions, and/or other type designations, such as entity type (vendor, client, etc.) within the relevant communications network) from which the viewing user could select in order to complete the interactive Contact Initiator Type input field 1215. For example, in a healthcare setting, a viewing user might want to see the pending communications initiated by pharmacists. So the viewing user could check the Contact Initiator Type 1211 selection criteria option and then could either enter into an identifier for Pharmacists into the interactive Contact Initiator Type input field 1215, or could click on the corresponding pull-down menu button 1220, which would in turn present a pull-down menu (not shown) of names and/or identifiers for Contact Initiator Types from which the viewing user could select an identification of Pharmacists in order to complete the interactive Contact Initiator Type input field 1215.

Similarly, for the other exemplary view selection criteria options Contact Target 1221, Contact Target Type 1231, Contact Initiator Organization 1241, Contact Initiator Department 1251, Contact Target Organization 1261, and Contact Target Department 1271, the exemplary embodiment would provide an exemplary corresponding pull-down selection button (1230, 1240, 1250, 1260, 1270, 1280 respectively) and an exemplary corresponding interactive input field (1225, 1235, 1245, 1255, 1265, 1275 respectively) with which the exemplary viewing user could selectably define a view of the exemplary pending communication queue.

The exemplary view selection criteria depicted in FIG. 12 is visually referenced as “pending.” However, as depicted in FIG. 12, a user would be provided with options to select viewing of Pending Only 1291 contacts, All contacts 1292, or contacts Pending for more 1293 than an interactively identifiable number 1294 of minutes.

Once a viewing user had elected pending contact queue viewing criteria, the exemplary embodiment would analyze the relevant contact queue and (in some cases, with respect the relevant timing of pending for more 1293 than said interactively identifiable number 1294 of minutes), and would generate a viewable report display to a display monitor accessible by the viewing user's computer device.

As indicated above by the exemplary option to select reporting criteria to include all contacts 1292, an exemplary embodiment would not delete completed contacts from its accessible computer storage. Rather, those contacts that have been completed would not be listed (unless expressly requested) in a “pending” contact queue display.

As depicted in FIG. 11, the exemplary embodiment would comprise software that would report for each call queue entry, an exemplary status 11020 of the call/contact, an exemplary date 11030, an exemplary time 11040, an exemplary caller 11050, an exemplary caller type 11060, an exemplary reason 11070, an exemplary patient name 11080, and an exemplary care center 11090.

In addition to the above-mentioned exemplary text fields (11020-11090) illustratively depicted in exemplary FIG. 11, as further depicted in FIG. 11, the exemplary embodiment would comprise software that would provide exemplary HIPAA information for each entry (if available and/or entered) in the form of an exemplary activatable link, e.g., HIPAA-LINK1 11101, HIPAA-LINK2 11102, and HIPAA-LINK3 11103, such as a hypertext link, that would provide secure access (e.g., password-protected access and/or biometric-protected access) to patient-specific HIPAA data.

The exemplary embodiment would further comprise software that would provide exemplary medical information for each entry (if available and/or entered) in the form of an exemplary activatable link, e.g., MED-DATA-LINK1 11111, MED-DATA-LINK2 11112, and MED-DATA-LINK3 11113, such as a hypertext link, that would provide secure access (e.g., password-protected access and/or biometric-protected access) to patient-specific medical information.

By displaying such activatable links to patient-specific HIPAA and Medical data, the exemplary call list queue displays non-confidential text data (e.g., the above-mentioned exemplary text fields (11020-11090) illustratively depicted in exemplary FIG. 11) that may be reviewed by a general viewing population (e.g., callers, potential callers, call targets and/or call target assistants), and would also provide secure access to confidential patient-specific HIPAA and medical information that could only be accessed by an authorized healthcare provider that is authorized to view such patient-specific confidential information.

In one embodiment, clicking on a hypertext link, such as, for example, exemplary HIPAA-LINK1 11101, the exemplary embodiment would comprise software that would present the user attempting to access the information with a security window that would require password and/or other similar types of authorization verification. Alternative exemplary embodiments would require biometric entry, such as using a biometric reader of the accessing user's smartphone, of biometric data and would verify the data against information in a server-accessible database for the relevant patient.

### Determination and Analysis of Healthcare Provider Communication Patterns

Exemplary embodiment implemented for, e.g., organizations, or a network of organizations, healthcare or otherwise, would extract information from call/contact list queue entries for exemplary call targets and would determine various types of statistical information.

For example, an exemplary healthcare-setting embodiment would extract information from call/contact list queues for exemplary call targets and would determine statistical information regarding such things as healthcare provider return-call time and time for healthcare issue resolution, and would develop return-call time and issue resolution time patterns, including with respect to call reasons, caller, location, time of calls, detailed medical data, and other criteria. Exemplary embodiments would further facilitate creation of various types of statistical and pattern reports for healthcare provider review and patient care process improvement.

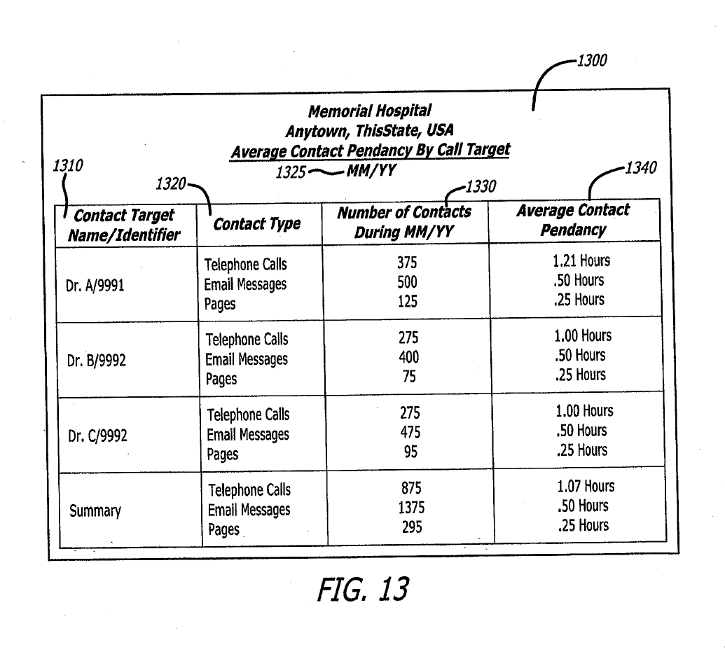

FIG. 13 is a graphic depiction of an exemplary statistical report that would be viewable by an exemplary healthcare-setting embodiment. The exemplary embodiment would provide various statistical reporting criteria (not shown) with which a reviewing user would be able to define various statistical reporting views. Once selected by the reviewing user, the exemplary embodiment would use the selected criteria to analyze the contact queue for the relevant statistical reporting period, e.g., during a particular month (MM/YY), and generate a viewable report display to a display monitor accessible by the viewing user's computer device.

FIG. 13 illustratively depicts an exemplary statistical report that could be interactively provided according to statistical reporting criteria selected by a reviewing user, or which in some embodiments could be automatically provided by default. FIG. 13 illustratively depicts an exemplary Average Contact Pendancy By Call Target statistical report that could be used by a healthcare organization to determine if it's call-response-timing by-laws were being met. As depicted in FIG. 13, an exemplary Average Contact Pendancy By Call Target statistical report would display each Contact Target Name/Identifier 1310, the relevant Contact Types 1320 that had been made during a particular reporting time period, e.g., 1325, the Number of Contacts made during the particular reporting time period 1330, and the Average Contact Pendancy 1340 for each Contact Type.

### Further Alternative Exemplary Embodiments

One further alternative exemplary embodiment would be implemented to track, analyze and manage communications across various individual “apps” (software applications) that may be resident/installed on personal smartphones. For example, each “app” on a personal smartphone may provide a distinct communication purpose, and/or may comprise communications with and/or for different members/users. A further alternative exemplary embodiment would comprise software that would track, analyze and manage data from each individual app on a particular personal smartphone and would provide overall cross-app (across various individual “apps”) display and analysis of communications and communication patterns for the user of the particular personal smartphone.

One yet further alternative exemplary embodiment would be implemented in non-healthcare-setting, commercial organizations, such as commercial organizations that tend to experience large call/communication volumes. Such a further alternative exemplary commercial embodiment would comprise computer software for call queuing, call/contact response tracking, statistics gathering and statistics reporting, the use of which may improve call/contact and call/contact resolution coordination and processing, thereby improving customer service and satisfaction as well as work efficiency. For example, an exemplary commercial organization employee A needs to call a supplier to follow-up on an exemplary commercial order; at the same, or close in, time, exemplary commercial organization employee B needs to call the same supplier with different question, perhaps concerning a different order. In such an exemplary situation, response time by the supplier may be important to order fulfillment; a further alternative exemplary commercial embodiment would comprise software that would provide communications coordination, tracking and statistical data that would be useful to manage the particular exemplary sequence of calls to the same supplier and would further be useful for the respective ordering and supplier organizations to manage and improve their processes.

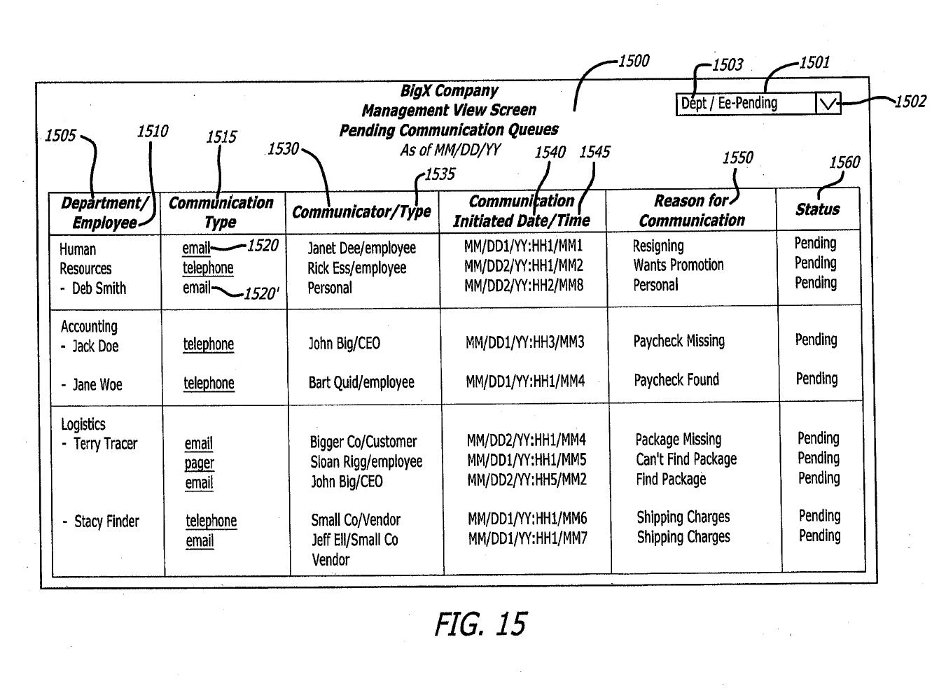

FIG. 15 is a graphic depiction of an exemplary management view screen 1500 in an exemplary organizational commercial embodiment. As depicted in FIG. 15, an exemplary management view screen 1500 would provide an exemplary view of exemplary pending communication queues for employees 1510 (and/or, e.g., departments 1505). The exemplary management view screen 1500 depicted in FIG. 15 would be organized by Department 1505, and within Department, by Employee 1510.

As will be understood by someone with ordinary skill in the art, other management views could be provided without departing from the spirit of the present invention. The exemplary organizational commercial embodiment depicted in FIG. 15 would provide management reporting selection criteria (e.g., with a selection criteria input field 1501 and pull-down menu button 1502 that would display a pull-down menu of selection criteria options (not shown)) that would facilitate a user-specified management view of pending communications. For example, an exemplary organizational commercial embodiment would provide (not shown) management view reporting selection criteria options (e.g., with a pull-down menu (not shown)) that would facilitate creation of a management view screen that, instead of being organized by department, would instead be sorted to show the longest-pending communication (for an employee and/or for a particular department) in order of the time pending. An alternative selection criteria option (such as in an exemplary pull-down menu) would facilitate creation of a management view screen that would be sorted to show the employee with the largest number of pending communications. Yet further, a further alternative selection criteria would facilitate creation of a management view screen that would show the department with the greatest number of pending communications.

The exemplary organizational commercial embodiment would categorize pending communications (including telephone calls, emails, pagings, text messages, and the like) for a communication-recipient (whether individual, department, or other organizational unit) according to communicator-initiator type (e.g., customers, vendors, suppliers, employees, executives, or others).

Continuing with reference to FIG. 15, the exemplary management view screen 1500 depicted in FIG. 15 would provide an exemplary view of exemplary pending communication queues for employees 1510 within each department 1505 (according, e.g., to the particular Dept/Ee—Pending selection criteria option 1503 selected by the particular user). Other section criteria would provide, for example, summaries by Department (pending and/or other types of status), by Communicator, by Communicator type, by Reason, Communications that were pending longer than “X” minutes (or hours; where the “X” would be a user-identified number), and others.

For each pending communication, the exemplary management view screen 1500 depicted in FIG. 15 would provide an indication of the communication type 1515. For some reported communications, the exemplary organizational commercial embodiment would provide an exemplary activatable link 1520, such as, for example, a hypertext link, to a more detailed screen (not shown) that would provide more details about the particular pending communication. As illustratively depicted in FIG. 15, such an exemplary activatable link 1520 would be provided for non-personal pending communications; for personal communications, e.g., 1520′, no link to more details about the communication would be provided.

As will be understood by someone with ordinary skill in the art, the illustrative depiction of filtering for personal versus non-personal communications is non-limiting. Rather, in other exemplary embodiments, filtering criteria could be specified by an administrator to govern whether or not personal communications would be reported on a pending communication view, and/or whether details concerning personal communications could be viewed. In yet other exemplary embodiments, filtering personal communications would be done automatically, so that personal communications would not be reported on a pending communications queue report for management review.

Continuing with reference to FIG. 15, the exemplary management view screen 1500 depicted in FIG. 15 would further provide (e.g., for non-personal communications) an indication of the Communicator (Initiator) 1530 and the type of Communicator 1535 (e.g., Vendor, employee, executive, customer, etc.). For each entry, a Communication Initiated Date 1540 and Communication Initiated Time 1545, as well as a Reason for the Communication 1550 and a Status 1560. In some exemplary organizational commercial embodiments, such as the one depicted in FIG. 15, only pending Status communications would be reported. However, other exemplary organizational commercial embodiments would provide management with the option (such as with the exemplary reporting selection/sorting criteria) of viewing additional status-types, such as, but not limited to, completed communications, and cancelled communications.

Exemplary organizational commercial embodiments would provide exemplary statistical summary reporting (not shown) similar to other types of statistical reports mentioned herein.

Such management summaries of communications and statistical reporting would provide viewing management with tools with which to identify communication bottlenecks, and/or specific communication issues, for the subject company/organization so that some procedure(s) could be taken to resolve issues.

A still further alternative exemplary embodiment would be implemented in a social media setting. An exemplary social media embodiment would comprise software that would display a “call/contact queue” to show pending communications from various users, friends, followers or other contact types to call target users (e.g., such as those that have a large volume of followers or friends) on different social media platforms. The ability to review cross-social-media platform communications would allow a social media call/contact target to more efficiently respond to social media communications. Further, the additional information shown by an exemplary “call queue” list would be helpful in allowing a receiving social media call target to review the list of social media “callers” (contactors, users, friends, followers and the like) and respond accordingly. Social media users that have large followings and/or that use social media to, e.g., advance commercial interests, may use statistics produced by such an exemplary social media embodiment to improve their response to contacting users and friends. Alternatively, statistical information provided by such an exemplary social media embodiment could be used by the respective social media organizers to rank users and/or for other reasons.

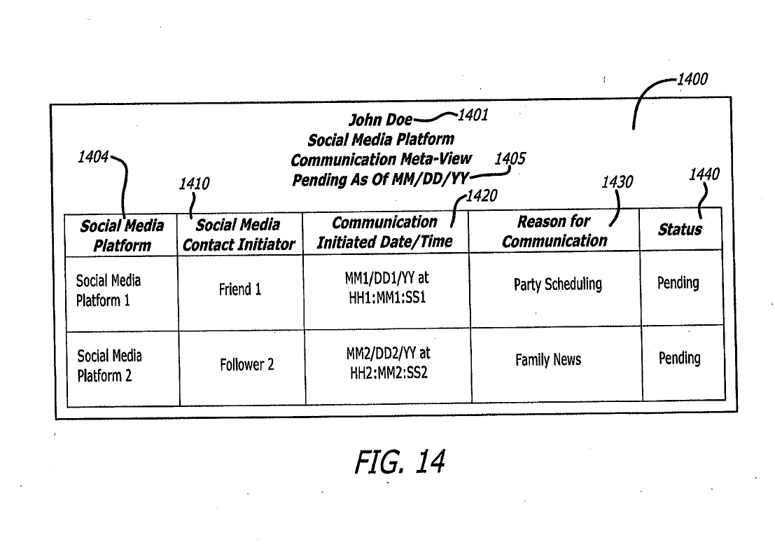

FIG. 14 illustratively depicts an exemplary Social Media Platform Communications Meta-View display 1400 of communications pending as of particular date 1405 for a particular social media user 1401. As depicted in FIG. 14, an exemplary Social Media Platform Communications Meta-View display 1400 would comprise a display of each social media communication for a plurality of social media platforms 1404, for a plurality of social media contact initiators 1410, initiated on a particular date and time 1420, for a particular reason 1430 with a particular status 1440.

As will be understood by someone with ordinary skill in the art, the illustrative depiction of the exemplary Social Media Platform Communications Meta-View display 1400 is non-limiting; other types of information and/or other ways of displaying the information could be provided in other exemplary embodiments.

### Facsimile Reproduction of Copyright Material

A portion of the disclosure of this patent document contains material which is subject to copyright protection by the copyright owner(s), Dr. Steven Wang, M.D., and/or his successors and assigns. The copyright owner(s) has/have no objection to the facsimile reproduction by anyone of the patent document or the patent disclosure, as it appears in the Patent and Trademark Office patent file or records, but otherwise reserves all copyright rights whatsoever.

### Illustrative Embodiments

Although this invention has been described in certain specific embodiments, many additional modifications and variations would be apparent to those skilled in the art. It is, therefore, to be understood that this invention may be practiced otherwise than as specifically described. Moreover, to those skilled in the various arts, the invention itself herein will suggest solutions to other tasks and adaptations for other applications. Thus, the embodiments of the invention described herein should be considered in all respects as illustrative and not restrictive, the scope of the invention to be determined by the appended claims and their equivalents rather than the foregoing description.

What is claimed is:

1. A computer system for communication management and tracking, said computer system comprising at least one computer device programmed to perform the following processes:
identifying a plurality of data elements for each contact between members of a communications network, said data elements for each contact comprising:
an identification of a contact-initiator,
an identification of a contact-target,
a time of an initiation of a contact by said contact-initiator directed to said contact-target,
a time of completion of a return-answer contact by said contact-target to said contact initiator, and
a status of said contact, wherein said status comprises a completed contact where said time of completion has been identified, but where said status comprises a pending contact where said time of completion has not yet been identified;
creating an entry in a pending communications queue on a computer-accessible storage device for each contact for which the status of said contact is pending; and
generating a visual display on a computer-accessible display device of each pending contact.

2. The computer system of claim 1, wherein said set of pending contact display criteria comprises an identification of a particular contact-target.

3. The computer system of claim 1, wherein said data elements for each contact further comprise an identification of a contact-target type, and wherein said set of pending contact display criteria comprises an identification of a particular contact-target type.

4. The computer system of claim 1, wherein said communications network comprises a plurality of social media platforms.

5. The computer system of claim 1, wherein said communications network comprises a plurality of software applications installed on a particular personal intelligent telephone.

6. The computer system of claim 1, wherein said generating a visual display on a computer-accessible display device of each pending contact comprises generating said visual display according to a set of pending contact display criteria selected by a viewing user.

7. The computer system of claim 1, wherein said generating a visual display on a computer-accessible display device of each pending contact comprises generating said visual display of each pending contact for a particular contact-target.

8. The computer system of claim 1, said data elements for each contact further comprising a contact-initiator type, wherein said generating a visual display on a computer-accessible display device of each pending contact comprises generating said visual display of each pending contact for a particular contact-initiator type.

9. The computer system of claim 1, said data elements for each contact further comprising a contact-target type, wherein said generating a visual display on a computer-accessible display device of each pending contact comprises generating said visual display of each pending contact for a particular contact-target type.

10. A computer system for communication management and tracking, said computer system comprising at least one computer device programmed to perform the following processes:
identify a plurality of data elements for each communication between a plurality of members of a communications network;
creating an entry in a pending communications queue on a computer-accessible storage device for each communication for which a status of said communication has not yet been answered by a relevant call target.

11. The computer system of claim 10, said at least one computer device further programmed to further perform the following processes:
generating a visual display on a computer-accessible display device of each communication that has not yet been answered by a particular call target.

12. The computer system of claim 11, said at least one computer device further programmed to further perform the following processes:
generating for display in said visual display a hypertext link that is active for secure access to confidential healthcare information.

13. The computer system of claim 12, said at least one computer device further programmed to further perform the following processes:
responding to a user activation by an accessing user of said hypertext link, present to a display device associated with a computer device associated with said accessing user a security validation input display.

14. The computer system of claim 13, said at least one computer device further programmed to further perform the following processes:
responding to user input of security validation information by said accessing user, test said security validation information.

15. The computer system of claim 14, said at least one computer device further programmed to further perform the following processes:
for security validation information tested as authenticated, allow said accessing user to access said confidential healthcare information; and
for security validation information that is not authenticated, deny said accessing user access to said confidential healthcare information.

16. The computer system of claim 10, wherein said at least one computer device is further programmed to integrate said processes with an electronic medical records system and wherein said at least one computer device is further programmed to facilitate voice over Internet protocol audio and video communications.

17. A computer system for communication management and tracking, said computer system comprising at least one computer device programmed to perform the following processes:
identify a plurality of data elements for each communication between a plurality of members of a communications network;
creating an entry in a communications queue on a computer-accessible storage device for each communication between each member of the plurality of members of said communications network;
responding to a selection by a viewing user of at least one data element of said plurality of data elements, generate a visual display on a computer-accessible display device according to said selection.

18. The computer system of claim 17, wherein said plurality of data elements comprise an identification of a contact-initiator, an identification of a contact-target, and a status of a communication, wherein said selection comprises a selection of a particular contact-target, wherein said generate said visual display comprises generating a visual display of communications to said particular contact target that have a pending status.

19. The computer system of claim 17, wherein said communications network comprises a plurality of social media platforms.

20. The computer system of claim 17, wherein said communications network comprises a plurality of software applications installed on a particular personal intelligent telephone.
